(19) United States
(12) Patent Application Publication
(10) Pub. No.: US 2009/0015599 A1
(43) Pub. Date: Jan. 15, 2009

(54) DRAGGABLE MECHANISM FOR IDENTIFYING AND COMMUNICATING THE STATE OF AN APPLICATION

(75) Inventors: Jeffery Bennett, San Francisco, CA (US); Peter Shafton, San Francisco, CA (US); Tomi Blinnikka, Berkeley, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/775,097

(22) Filed: Jul. 9, 2007

(51) Int. Cl. G09G 5/00

(52) U.S. Cl. 345/680

(57) ABSTRACT

In a method and system for identifying and communicating a state of an application, a namespace is defined for a draggable mechanism. The draggable mechanism is located within an application window housing an application. Metadata identifying application state information is appended to a URL embedded within the draggable mechanism to reflect a first application state of the application. The metadata identifying the application state information is updated at a predetermined interval to reflect new application states.

### BACKGROUND

1. Field of the Invention

Aspects of the present invention relate generally to software and Internet applications, and more particularly to a system and method for a draggable mechanism which identifies and communicates the state of an application.

2. Description of Related Art

During execution of a software application, the application may have many states. A state of an application may be defined as an occurrence of an event in the application. An application event occurrence differs per application or even within an application. For example, a video player application may measure application states in terms of each second or multiple or fraction of a second elapsed in a video file being executed by the video player, where a new state occurs during each such time interval. The same video player alternatively may measure application states in terms of the number of frames elapsed for a video. In another example, a word processing application may measure application states by a predetermined number of characters typed in a word processing document, e.g., every ten characters typed is a new application state, or alternatively, by a predetermined interval of time, e.g., every ten minutes the document is active is a new application state.

Currently, several standardized processes exist to communicate a state of an application to other applications. These processes include Component Object Model (COM), MessageBus, and AppleScript™. A disadvantage of these communication standards is that they are often not accessible to an end user, as these standards are employed by application developers during the development of an application. Further, these communications processes do not communicate application states to other applications graphically. As a result, no user-friendly mechanism exists for communicating an application state to another application.

Thus, it would be desirable to provide a method and system for identifying and communicating a state of an application to other applications.

### SUMMARY

Embodiments of the present invention overcome the above-mentioned and various other shortcomings of conventional technology, providing a method and system for identifying and communicating a state of an application.

In accordance with one aspect, a namespace is defined for a draggable mechanism. The draggable mechanism is located within an application window housing an application. Metadata identifying application state information is appended to a URL embedded within the draggable mechanism to reflect a first application state of the application. The metadata is updated at a predetermined interval to reflect changed application states.

The foregoing and other aspects of various embodiments of the present invention will be apparent through examination of the following detailed description thereof in conjunction with the accompanying drawing figures.

### BRIEF DESCRIPTION OF THE DRAWING FIGURES

FIG. 1 is a diagram illustrating a generic format of a Uniform Resource Identifier.

FIG. 2 is a diagram illustrating one embodiment of a mechanism for identifying a state of an application.

FIG. 3 is an exemplary screenshot of a draggable mechanism for identifying a state of an application.

FIG. 4 is an exemplary screenshot of a draggable mechanism communicating a state of an application.

FIG. 5 is a simplified flowchart illustrating one embodiment of a method for identifying a state of an application.

FIG. 6 is a simplified flowchart illustrating one embodiment of a method for communicating a state of an application.

### DETAILED DESCRIPTION

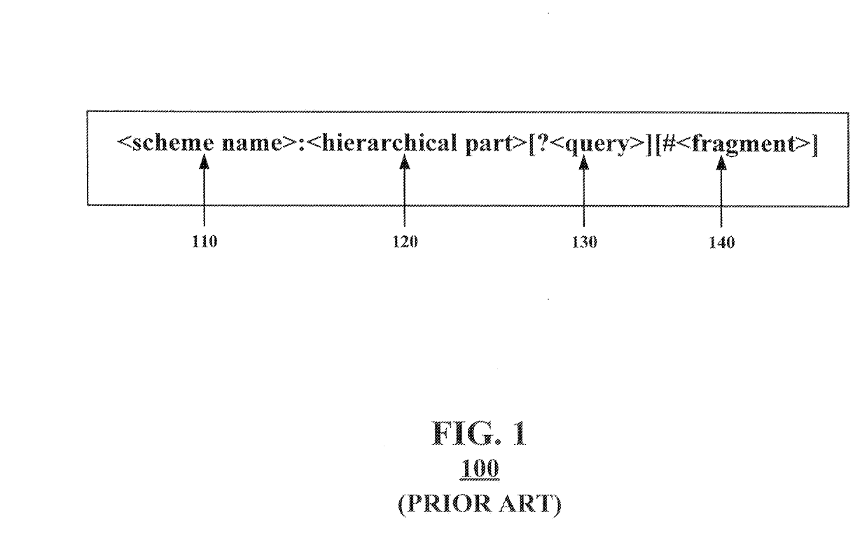

FIG. 1 is a diagram illustrating a generic format of a Uniform Resource Identifier (URI). A URI generally is a compact sequence of characters that identifies an abstract or physical resource. The syntax of a URI permits the parsing of components of a URI reference without knowledge of scheme-specific requirements of every possible component. Each URI begins with a scheme name 110 which refers to a specification for assigning identifiers within the scheme. The URI scheme name defines the syntax and semantics needed to parse a URI reference into components. Commonly known URI schemes include http (hypertext transfer protocol), ftp (file transfer protocol), snmp (simple network management protocol), dns (domain name system), mailto (SMTP email addresses), etc. Commonly, an authority or hierarchical part 120 follows the scheme name 110, and governs the namespace defined by the remainder of the URI. The hierarchical part 120 may include optional user information, a hostname, such as a domain name or IP address, and an optional port number preceded by a colon (‘:’). The hierarchical part is typically delimited from the scheme name by a double slash “//” and is terminated by either a single slash ‘/’, a question mark ‘?’, or a hash character ‘#’. The hierarchical part may be optionally followed by a path component, provided that the path component is separated from the hierarchical part by a single slash ‘/’. A query 130 may identify a resource within the scope of the URI's scheme and namespace, together with the path or alone. A query 130 is designated by the first question mark ‘?’ in the URI and ends with a hash or pound character ‘#’. A fragment identifier component 140 may permit indirect identification of a secondary resource and any additional identifying information. Fragment identifiers 140 also may be used in client-side indirect referencing, allowing an author to specifically identify portions of an existing resource that are only indirectly provided by the resource owner. As a result, a fragment identifier may not be used in the scheme-specific processing of a URI, and dereferencing of the fragment identifier may occur independently of the URI processing.

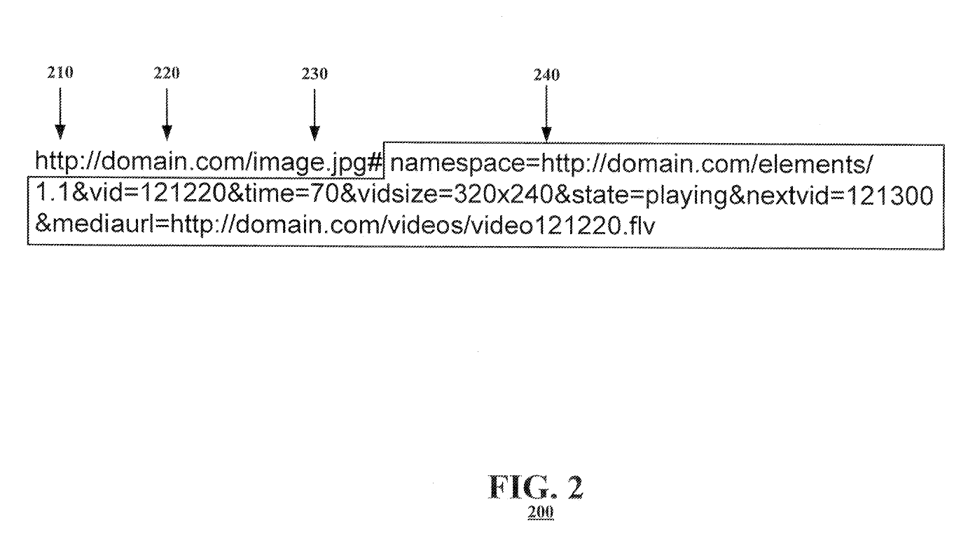

FIG. 2 is a diagram illustrating one embodiment of a mechanism for identifying a state of an application. In one embodiment, this mechanism may take the form of a URI or Uniform Resource Locator (URL) with metadata embodying additional state information appended in the fragment identifier portion of the URI. A URL is a subset of a URI in which the URL not only identifies a resource, but also provides a location for the resource, e.g., a network location of the resource. The URI may include a scheme name 210, which, in this embodiment, is the http scheme used for, among other things, publishing and retrieving html documents. The URI may also include a hierarchical component 220, such as a domain name. The URI may also include a path 230 to further identify the resource location. In the context of this embodiment, the scheme name 210, hierarchical component 220, and path component 230 may identify an image of the JPG format.

In this embodiment, while the mechanism may point to a location of an image, such that an image is displayed in a web browser, through the fragment component of the URI, the mechanism also may identify the state of an application which plays a video or multimedia file. The fragment component 240 may specify a namespace that is defined in a way to enable other applications to parse and process this mechanism. In this embodiment, the namespace may define a URL which has its own scheme, hierarchical component, path, and queries. The queries may serve to identify various aspects of the state of the video or multimedia file being executed on the video player application. In this embodiment, such aspects may include a video identifier, the current time elapsed of the video file being played, the size or resolution of the video file, whether the video file is currently being played or is paused or stopped, the identifier of the next video to be played, and the URL of the video file. Those of skill in the art should recognize that the various characteristics of the state of an application are not limited to these aforementioned characteristics, and that metadata embodying the characteristics or properties disclosed in the query component of the fragment component are entirely exemplary. Those of skill in the art should also recognize that the properties used to identify or describe a state of an application may vary and depend on the type of application. The type of application is not limited to a video or a multimedia application, but could be any application that can have different states at different times, and thus is amenable to the approach of the present invention.

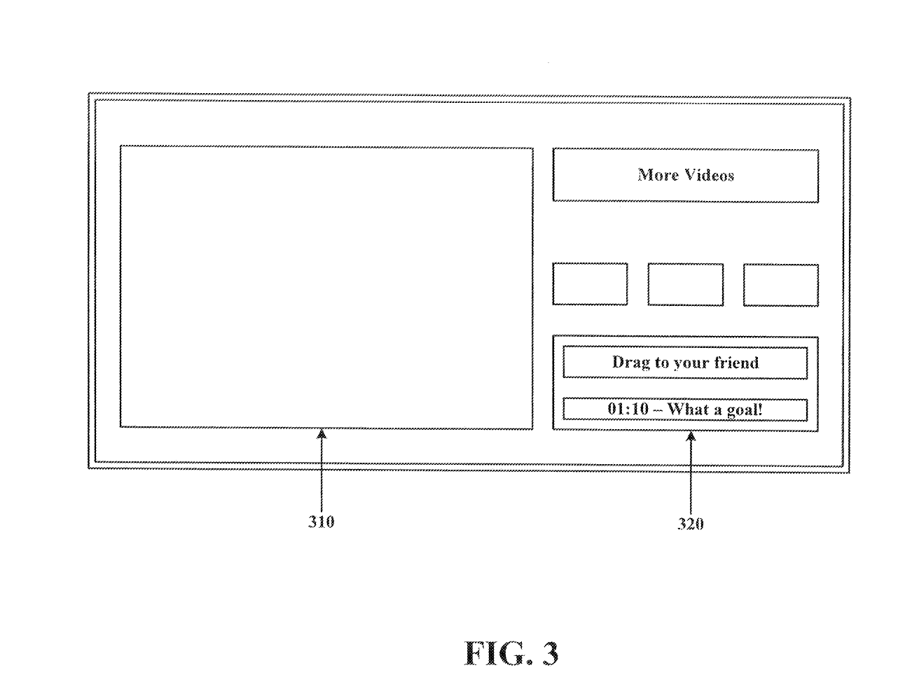

FIG. 3 is an exemplary screenshot of a draggable mechanism for identifying a state of an application. The screenshot discloses a video or multimedia player 310 embedded in a web page. The multimedia player may play video or multimedia files. Embedded or placed within the web page, in this embodiment, adjacent to the video player may be a draggable mechanism 320 for identifying a state of an application. The draggable mechanism 320 may be a URI, as disclosed in the embodiment of FIG. 2, in which an image or graphic is displayed as a result of the URI identifying the image or graphic through the URI scheme name, hierarchical component, and path component. Alternatively, the draggable mechanism may be a text box, an icon, or any other object which may be dragged or cut-and-pasted from one application to another. Metadata identifying application state information related to the state of the multimedia player may be embedded in the image or graphic embodying the draggable mechanism 320. Within the URI defining the draggable mechanism 320, the application state information may be appended to the URI and found in the fragment component 240. For each application state change, the mechanism may update the metadata identifying the application state information appended to the fragment component 240. The draggable mechanism may be created and updated using Javascript or other programming languages. By using Javascript or other programming languages, the application state information may be updated for each application state change without refreshing or reloading the image identified in the URI or otherwise disrupting the executing application.

In one embodiment, multiple draggable mechanisms may be saved and stored to identify different states of an application. For example, a draggable mechanism for a word processing application may be dragged to a location different from the location of the application after each application state change. In one embodiment, for the word processing application, application state changes may be defined to occur every predetermined number of characters or at a predetermined time interval. Prior to each application state change, a user may drag the mechanism to a location different from the location of application to save that particular state of the application in the event the user needs to access a previous state. When the application state changes, the draggable mechanism may then update the application state information to reflect a new application state.

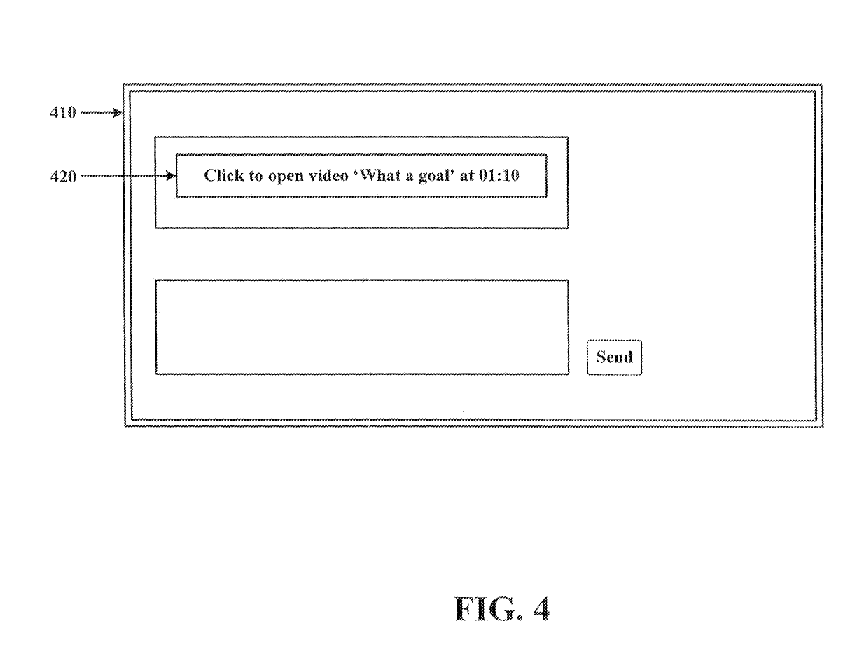

FIG. 4 is an exemplary screenshot of a draggable mechanism communicating a state of an application. In this embodiment, a state of an application, such as the multimedia video player 310 of FIG. 3, may be identified by a draggable mechanism 320 through the application state information appended to the URI embedded within the mechanism. The draggable mechanism 320 may be dragged from the video player to a different application, such as an Internet messaging application 410. Generally, based on the defined namespace associated with the appended application state information, any application may be designed or created to process draggable mechanisms. For example, applications created using Adobe Integrated Runtime or any other application development software supporting drag-and-drop functionality may process draggable mechanisms. In this embodiment, the draggable mechanism 320 may be communicated to another user of the Internet messaging application through an “instant message” or chat window. Those of skill in the art should recognize that the draggable mechanism may be conveyed to other users in other manners, such as through email or other interpersonal electronic communication methods. Upon receipt of the draggable mechanism 420, the recipient may access the mechanism by clicking on mechanism to launch, in this embodiment, a multimedia player to play the video or multimedia file at the same state at which the video file was playing on the transmitting party's multimedia or video player.

Upon execution of the mechanism, the multimedia file may be played at the same state on a multimedia player on the recipient's computing device through the Internet messaging application's parsing of the application state information appended to the URI embedded within the mechanism. Because the fragment component 240 of the URI includes a namespace defined in such a manner as to enable other applications to properly parse and process the application state information, the Internet messaging application may parse the metadata identifying application state information appended to the URI of the draggable mechanism and launch the application needed to play or execute the video identified by the URL within the appended application state information.

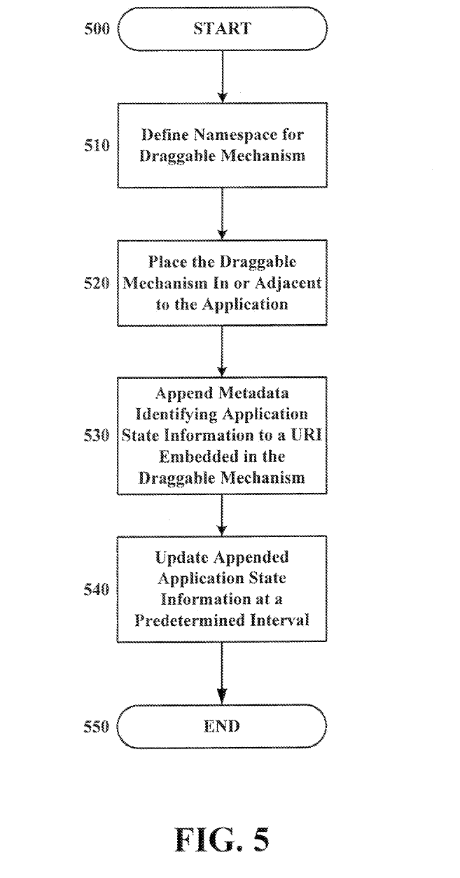

FIG. 5 is a simplified flowchart illustrating one embodiment of a method for identifying a state of an application. In block 510, a namespace may be defined to enable other applications to parse a URI embedded within a draggable mechanism. The URI may point to or identify the location of a graphic or image. In block 520, the draggable mechanism may be placed within an application window of an executing application, such that the graphic or image identified by the URI may appear in the application window. In block 530, metadata identifying a state of the application may be appended to the URI within the fragment component of the URI. The fragment component may be separated from the URI through the use of a hash or pound character (‘#’). Use of the hash character ‘#’ prevents an application which dereferences the embedded URI from attempting to process the fragment component as part of the URI. In block 540, the metadata reflecting the application state information may be updated at a predetermined interval corresponding to a change in the state of the application. In one embodiment, for a multimedia video player, the application state information may be updated every second a video file plays, or alternatively, every predetermined number of elapsed frames. In one embodiment, for a video game, the application state information may be updated every time a new level is reached, or if the game is a sports game, for every quarter or period elapsed. In one embodiment, for a music application, such as Yahoo Music Jukebox™ or Apple iTunes™, application state information may be updated every time a new song is added or deleted from a playlist, or every time a new song is added or downloaded to the application. These embodiments are entirely exemplary, and as such, should not be considered as limiting the invention. The process ends in block 550.

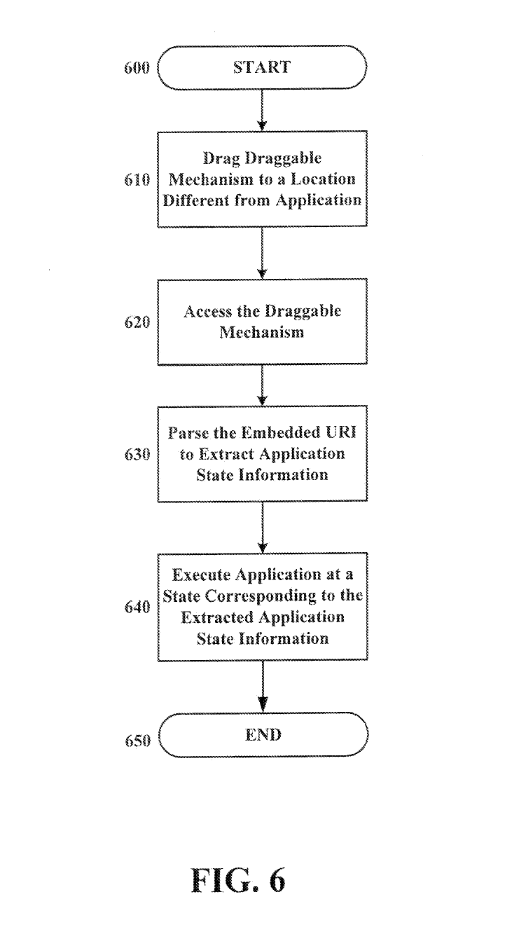

FIG. 6 is a simplified flowchart illustrating one embodiment of a method for communicating a state of an application. In block 610, a draggable mechanism which contains appended metadata identifying a state of an application may be dragged from the application to a location different from the location of the application. The different location may include other applications housed in other application windows, or may be the desktop of a computing device operating system. Applications receiving the draggable mechanism may be created or designed to support drag-and-drop functionality. In block 620, the draggable mechanism may be accessed at the different location, whether it be an application or a desktop. In one embodiment, the mechanism may be a graphic or an icon whose execution or access may be the result of being clicked. In block 630, upon execution of the mechanism, parsing of the URI embedded within the mechanism may ensue to determine the components of the URI and what resources they identify, as well as to extract application state information contained within a fragment component of the URI. In block 640, after parsing is complete, the application identified by the extracted appended application state information may be executed at the state identified by the extracted application state information. In this respect, the state of the application may be communicated to a different application or a different user. The process ends in block 650.

Those of skill in the art will appreciate that a draggable mechanism may be enabled to facilitate the identification and communication of a state of an application. The present disclosure is not intended to be limited with respect to the type of application capable of having its state identified or communicated. For example, while embodiments described herein have been directed to Internet applications, and in particular to a multimedia video player, the invention is applicable to other Internet applications besides multimedia video players. Such Internet applications may include but are not limited to music applications, Internet office applications (i.e., word processing applications, spreadsheet applications, slideshow applications, database applications, etc.), photograph applications, and games. The invention also is applicable to non-Internet applications with minor variations to the definition of the namespace for the URI embedded within the draggable mechanism. Such applications may include but are not limited to office software, such as word processors, spreadsheet programs, and database programs, as well as games, music applications, photograph applications, and electronic testing applications. Moreover, application state information identifying a state of any of these applications may vary depending on the application, and should not be limited to only those properties or characteristics of application states described herein.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

1. A method for communicating a state of an application, comprising:
defining a namespace for a draggable mechanism;
on a graphical display, locating the draggable mechanism within an application window;
appending metadata identifying application state information to a URL embedded within the draggable mechanism to reflect a first application state; and
updating the appended metadata at a predetermined interval to reflect an updated application state.

2. The method of claim 1, further comprising:
dragging the draggable mechanism from the application window to a location within the graphical display different from a location of the application window;
accessing the draggable mechanism at the different location;
upon said accessing, parsing the embedded URL to extract the application state information from the metadata; and
responsive to the extracted application state information, executing the application at a state corresponding to the extracted application state information.

3. (canceled)

4. The method of claim 1, wherein the predetermined interval for said updating is defined by the draggable mechanism namespace.

5. The method of claim 4, wherein the predetermined interval is a measure of time.

6. The method of claim 4, wherein the predetermined interval is an application event.

7. (canceled)

8. (canceled)

9. The method of claim 1, wherein the predetermined interval is dependent on an application type.

10. A computer-readable medium encoded with a computer-executable program to perform a method comprising:
defining a namespace for a draggable mechanism;
on a graphical display, locating the draggable mechanism within an application window housing an application;
appending metadata identifying application state information to a URL embedded within the draggable mechanism to reflect a first application state; and
updating the metadata at a predetermined interval to reflect an updated application state.

11. The computer-readable medium of claim 10, the method further comprising:
dragging the draggable mechanism from the application window to a location within the graphical display different from a location of the application window;
accessing the draggable mechanism at the different location;
upon said accessing, parsing the embedded URL to extract the application state information from the metadata; and
responsive to the extracted application state information, executing the application at a state corresponding to the extracted application state information.

12. (canceled)

13. The computer-readable medium of claim 10, wherein the predetermined interval for said updating is defined in the draggable mechanism namespace.

14. The computer-readable medium of claim 13, wherein the predetermined interval is a measure of time.

15. The computer-readable medium of claim 13, wherein the predetermined interval is an application event.

16. (canceled)

17. (canceled)

18. The computer-readable medium of claim 10, wherein the predetermined interval is dependent on an application type.

19. A draggable mechanism for communicating the state of an application, comprising:
on a graphical display, a graphical icon located within an application window housing the application, said graphical icon configured to be dragged to a receiving application; and
a Uniform Resource Identifier (URI) embedded within said graphical icon, the URI comprising:
a scheme name defining a namespace for the URI, wherein the namespace defines identifiers corresponding to the application state;
a path identifying a location of the application; and
metadata identifying application state information, said metadata being separated from said scheme name and said path by a delimiting character.

20. The draggable mechanism of claim 19, wherein the delimiting character is a hash mark.

21. The draggable mechanism of claim 19, wherein said metadata is updated at a predetermined interval to reflect new application state information.

22. The draggable mechanism of claim 21, wherein the predetermined interval is defined in the namespace.

23. The draggable mechanism of claim 22, wherein the predetermined interval is a measure of time.

24. The draggable mechanism of claim 22, wherein the predetermined interval is an application event.

25. The draggable mechanism of claim 21, wherein the predetermined interval is dependent on an application type.

26. A system for communicating a state of an application, the system comprising:
an application housed in an application window;
a draggable mechanism located within the application window, said draggable mechanism comprising a graphical image and a Uniform Resource Identifier (URI) embedded within said graphical image, wherein said URI identifies a location for said graphical image and metadata identifying a state of said application appended to said URI; and
a receiving application supporting drag-and-drop functionality to:
receive said draggable mechanism;
parse said draggable mechanism to extract the metadata identifying the state of said application; and
execute said application at a state corresponding to the application state identified by the extracted metadata.

27. (canceled)

28. The system of claim 26, wherein said metadata is updated at a predetermined interval to reflect new application state information.

29. The system of claim 28, wherein the predetermined interval is defined in the namespace.

30. The system of claim 29, wherein the predetermined interval is a measure of time.

31. The system of claim 29, wherein the predetermined interval is an application event.

32. The system of claim 28, wherein the predetermined interval is dependent on an application type.

33. (canceled)

34. (canceled)
